(19) United States
(12) Patent Application Publication
(10) Pub. No.: US 2007/0061850 A1
(43) Pub. Date: Mar. 15, 2007

(54) Electronic device tuning system

(76) Inventor: Thanga S. Muthu, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/228,448

(22) Filed: Sep. 15, 2005

(51) Int. Cl. H04N 7/173

(52) U.S. Cl. 725/86; 725/88; 725/102; 725/87

(57) ABSTRACT

A consumer electronic device tuning system is disclosed. The system receives instructions form a user of the electronic device and converts the instructions into digital and/or analog signals. These command signals are then conveyed to a mapping unit which matches the command signals with available programs data mapped in a mapping table of the mapping unit with regard to the programs available with an electronic device. The mapping unit enables the electronic device to play the requested program.

### BACKGROUND

Frequency tuning in electronic devices for example TV, radio, cassette and/or disc players etc. is done manually by operating the electronic device itself in person or by using the remote control. The user of an electronic device presses a button relating to a specific channel number and the frequency is tuned based on an input channel number. The user, for tuning an electronic device for example a TV, is required to have prior knowledge of the channel number with respect to different entertainment networks. Similarly the user is required to have prior knowledge of the frequency for a respective radio station for tuning a radio and a track number of a particular song to play back such song via a disc player.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIGS. 1A-1D illustrates different embodiments of an electronic device tuning system.

FIG. 2 illustrates an embodiment of control unit

FIG. 3 illustrates an embodiment of mapping unit.

FIG. 4 illustrates an embodiment of mapping table generation process that may be implemented by the mapping unit.

FIG. 5 illustrates an embodiment of program select process that may be implemented by the control unit.

FIG. 6 illustrates an embodiment of electronic device tuning process that may be implemented by the system of FIG. 1.

### DETAILED DESCRIPTION

In the following detailed description, numerous specific details are described in order to provide a thorough understanding of the invention. However the present invention may be practiced without these specific details. In other stances, well known methods, procedures, components and circuits have not been described in detail so as not to obscure the present invention. Further, example sizes/models/values/ranges may be given, although the present invention is not limited to these specific examples.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

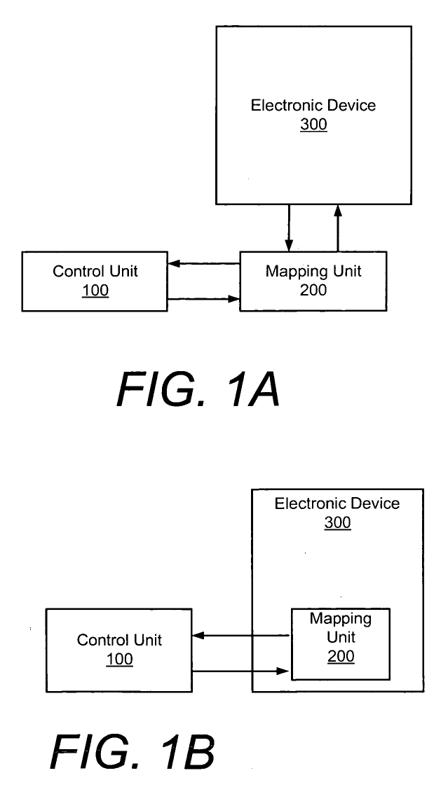

Referring to FIGS. 1A-1D, different embodiments of an electronic device tuning system are shown. The electronic device tuning system may comprise a control unit 100, a mapping unit 200 and an electronic device 300 like, for example, a TV, a radio, a cassette player, and/or a disc player.

In one embodiment and as depicted in FIG. 1A, a control unit 100 may be an independent unit to be used by a user as a remote control unit. The mapping unit 200 may also be a separate unit adapted to be coupled with an electronic device 300. The user controller 100 and the mapping unit 200 may communicate with each other. Also the mapping unit may communicate with an electronic device 300.

In another embodiment and as depicted in FIG. 1B, a mapping unit 200 may be provided as a built-in unit with an electronic device 300. A control unit 100 may be an independent unit to be used by a user as a remote control. The mapping unit 200 may be capable to communicate with the electronic device 300 and the control unit 100 may be capable to communicate with the mapping unit 200.

In yet another embodiment and as depicted in FIG. 1C, a control unit 100 may have a mapping unit 200 provided therewith and may be capable to communicate with each other and also with an electronic device 300. Combined unit of the control unit 100 and the mapping unit 200 may be used as an external unit to the electronic device 300 and may be capable to communicate with the electronic device 300.

In still another embodiment and as depicted in FIG. 1D, a control unit 100 may have a mapping unit 200 provided therewith. Combined unit of the control unit 100 and the mapping unit 200 may be provided as a built-in unit with an electronic device 300. The control unit 100 may communicate with the mapping unit 200 and the mapping unit 200 may communicate with the electronic device 300.

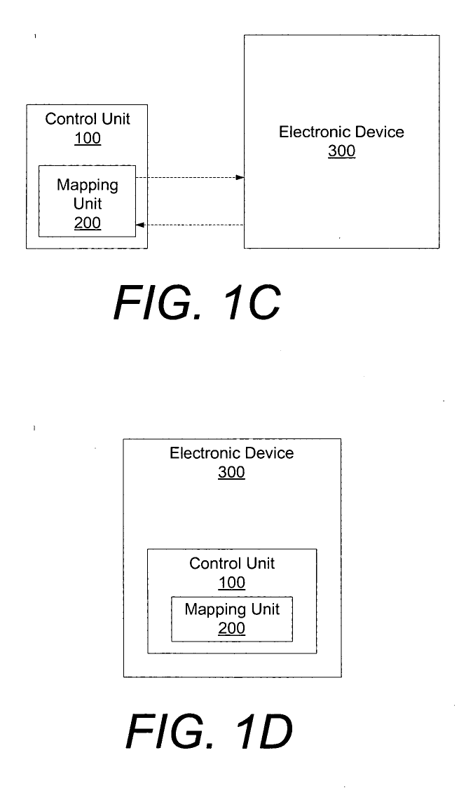

Referring now to FIG. 2, one embodiment of a control unit 100 is illustrated. As depicted, the control unit 100 may comprise a user interface 105 coupled with a processor 110. The processor 110 may be coupled with a memory 120. A mapping unit interface 115 may be coupled with the processor 110. The mapping unit interface 115 may be capable to communicate with a mapping unit 200 through a control unit interface 205 of the mapping unit 200.

The user interface 105 may receive instructions/requests for example spoken command from a user of an electronic device 300 and may convert the instructions into digital and/or analog signals. These digital/analog signals may be transmitted to the processor 110. The processor may process the signals and may read and/or write data from and into the memory 120 as per the instructions of the user. The processor 110 may retrieve the data from the memory 120 and transmit the data to the mapping unit 200 to enable the mapping unit 200 to tune the electronic device 300 as per the instructions of the user and to play the requested program.

The user interface 105 according to an embodiment may comprise a voice enabled unit or a touch screen unit or any other kind of unit capable to receive user command. The user interface 105 may further communicate the received user commands to the processor 110 of the controller unit 100. The user interface 105 may also comprise one or more output mechanisms such as a speaker, display screen, or other presentation device to present available programs data to a user.

The memory 120, as depicted, may comprise available program data 125 to store data regarding the programs available with the different electronic devices 300. The mapping unit interface 115 may be provided with the control unit 100 to facilitate receiving and/or transmitting information packets from and/or to the respective mapping unit 200 provided with different electronic device 300 and to transmit the information packets to the processor 110 with regard to the available programs.

The processor 110 may process the information packets and may store respective available program data 125 of the information packets in the memory 120 to store the data regarding the available programs with respect to a particular electronic device 300. The mapping unit interface 115 may transmit the instruction signals, received from the user of the electronic device 300, to the mapping unit 200 through a control unit interface 205 provided with the mapping unit 200. Similarly mapping unit interface 115 may receive information packets from the mapping unit 200 through a control unit interface 205 provided with the mapping unit 200.

In one embodiment the user may be able to select a category like for example sport, news, movies etc with the help of the control unit 100. The control unit 100 may send the signal to the mapping unit 200. The mapping unit 200 then may search for all channels that fall in that category and send the list of the available programs to the control unit 100. The control unit 100 may update the available program data 125 of the memory 120 based upon the received list of available programs.

In one embodiment the control unit 100 may be provided with voice recognition and transmission capability. When switched on, the control unit 100 may broadcast signals such as an IDLE signal to all available mapping units 200 in the electronic devices 300. The mapping units 200 on reception of the IDLE signals may know that it has as association with the control unit 100. The mapping unit interface 115 may be used by the control unit 100 to broadcast common system signals like for example IDLE, START, SHOUTDOWN etc., to the mapping units 200. In one embodiment dedicated frequencies may be used between the control unit 100 and mapping unit 200 to communicate between the control unit 100 and particular mapping unit 200 provided with an electronic device 300.

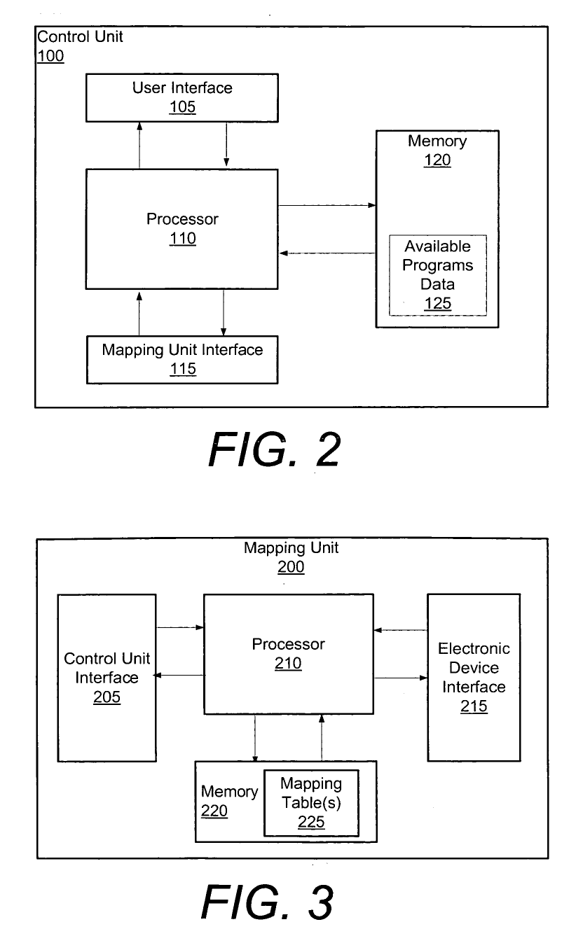

Referring now to FIG. 3, one embodiment of a mapping unit 200 is illustrated. The mapping unit 200 may comprise a control unit interface 205 that may be coupled with a processor 210. The processor 210 may be coupled with an electronic device interface 215. The processor 210 may also be coupled with a memory 220.

The mapping unit 200 may send a request to the electronic device 300 to fetch the information regarding available programs through the electronic device interface 215 and may receive the information packets from the electronic device 300 as per the request through electronic device interface 215. The information packets received from the electronic device 300 may be transmitted to the processor 210. Channel names may be obtained from the header information of the received broadcasted signals in particular frequency. For example TV telecast signals received have the channel names like AXN, HBO, ZTV etc, and radio signals received have channel frequency name like BBC, WIBC, ALL INDIA RADIO etc. This information may be used to build the mapping table 225 in the memory 220 with multiple records for example TV network names to corresponding TV channels, radio station names to corresponding frequencies, and/or song names to corresponding track number. This process of sending the request to the electronic device 300 to fetch the information may be repeated to obtain complete information regarding available channel names and the frequency. The mapping unit may be capable to convey the list of channel names available with the electronic device to the control unit 100 to facilitate selection of the TV channel, radio station and/or a particular song, by the user.

The processor 210 may process the information packets to identify the program and related playback information, for example, TV network names to corresponding TV channels, radio station names to corresponding frequencies, and/or song names to corresponding track numbers. The processor 210 may convey the information data to the memory 220 so as to store the information data in a mapping table 225 provided with the memory 220.

As depicted, the memory 220 may comprise one or more mapping tables 225 to store the information data that maps, for example, TV network names to corresponding playback TV channels selections, radio station names to corresponding playback frequencies selections, and/or song names to corresponding playback tracks selections relating to available programs with an electronic device 300.

In one embodiment and in case of multiple electronic devices 300 present in the house, the mapping unit 200 shall be provided for each electronic device 300. Each electronic device 300 may have a mapping table 225 built therein and stored in the memory 220 of the mapping unit 200. The mapping table 225 may have as many records as the broadcasting channels along with corresponding playback selections received by the electronic device 300. Once the mapping table 225 is built, the list of the channel names may be transmitted to the controller unit 100 and the mapping unit 200 may start receiving instructions from the user.

The control unit interface 205 may facilitate receiving and transmitting the information signals from and to a control unit 100. The control unit interface 205 may receive the information signal packets from the control unit 100 through the mapping unit interface 115 of the control unit 100 and may convey the signals to the processor 210 of the mapping unit 200.

The processor 210 may process the information signal packets. The processor 210 may further retrieve information from the memory 220 and may transmit the information to an electronic device 300 through an electronic device interface 215 so as to enable the electronic device 300 to play the required program.

In one embodiment and where the user may be expected to use different names for the same frequency for example MTV or Music Television for the same channel, the mapping unit 200 may maintain two different entries with MTV and frequency and Music Television and the same frequency to be able to provide flexibility for frequency selection and there by avoiding confusion. Similarly in case of CD/DVD players the control unit 100 may have available list of songs or movie from the player and display it to the user for selection.

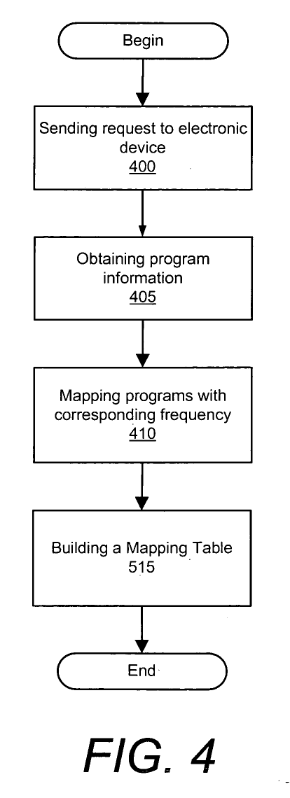

Referring now to FIG. 4, an embodiment of mapping table generation process implementable by the mapping unit 200 is illustrated. As depicted in block 400, the mapping unit 200 may send a request to the electronic device 300 to fetch the information regarding available programs through the electronic device interface 215. In one embodiment the request to fetch information may comprise a command field and a payload field. The command field may carry a request or response op-code (operational code) between the mapping unit 200 and an electronic device 300 so as to request information from the electronic device 300 regarding available programs the electronic device 300 has for playing. The payload field may carry mapping information and/or play back selections between the mapping unit 200 and the electronic device 300 such as, for example, TV network name to channel mappings, radio station name to frequency mappings, song name to track mappings and/or some other user friendly name that may be stored in the mapping table 225 of the mapping unit 200 to facilitate playback of a requested program.

In block 405, the mapping unit 200 may receive the information packets from the electronic device 300 as per the request through electronic device interface 215. The information packets received from the electronic device 300 may be transmitted to the processor 210 for processing and to obtain the information from the information packet. In one embodiment channel names may be obtained from the header information of the received TV telecast signals. Similarly radio stations name may be obtained from radio signals received by mapping unit 200.

In block 410, the processor 210 may map the program for example channel name with the particular frequency at which the information packet with header information was broadcasted. Also the name of the radio station may be mapped with the frequency at which the radio signals were broadcasted. Similarly the name of the songs or movie may be mapped with the track number received in the information packet by the mapping unit 200 from the electronic device 300.

In block 415, the processor uses the information received from the electronic device to build the mapping table 225 provided in the memory 220 with multiple records for example TV network names to corresponding TV channels, radio station names to corresponding frequencies, and/or song names to corresponding track numbers constituting corresponding playback selections. This process of sending the request to the electronic device 300 to fetch the information may be repeated again and again to obtain complete information regarding available programs and corresponding playback selections data available with the electronic device 300.

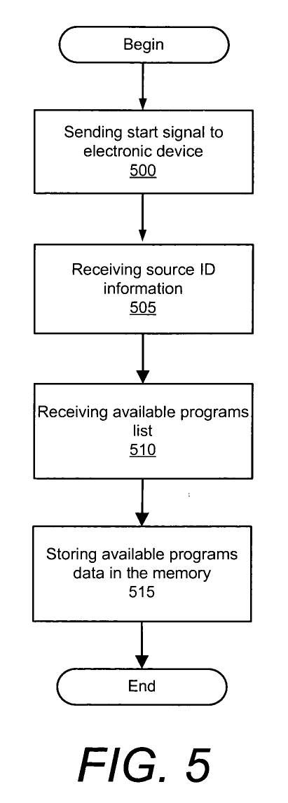

Referring now to FIG. 5, an embodiment of program selections process implementable by the control unit 200 is illustrated. As depicted in block 500, the control unit 100 may send START signal to the mapping unit 200 through mapping unit interface 115 and mapping unit 200 may start transmitting information packet to the control unit 100 through control unit interface 205, upon establishing an association of the mapping unit 200 with the control unit 100. In one embodiment the information packet may comprise a source ID field, a mapping information field and a checksum field. The mapping information field may comprise mapping information and/or playback selections regarding the available programs stored in a mapping table 225 of a memory 220 of the mapping unit 200. The checksum field may provide a checksum of the whole information packet to enable the control unit 100 to verify the data integrity of the received information packet.

In block 505, the control unit may receive source ID information from a mapping unit 200 through a mapping unit interface 115. The source ID information may be sent by the mapping unit through a control unit interface 205. The source ID field may specify the electronic device 300 from which the information has been sent.

In block 510, the control unit 100 may receive information packet through a mapping unit interface 115, regarding the available programs and corresponding playback selections data available and stored in the mapping table 225 provided in the memory 220 of the mapping unit 200 and convey the information packet to a processor 110 of the control unit 100. Available programs and corresponding playback selections data information may be sent by the mapping unit through a control unit interface 205.

In block 515, the processor 110 may process the information packet and may store available programs data 125 of the information packet in the memory 120 of the control unit 100. The available programs data can be seen by the user on the control unit and the user may search to select a desired program from the available programs data 125 and may select a program to be played by the electronic device 300.

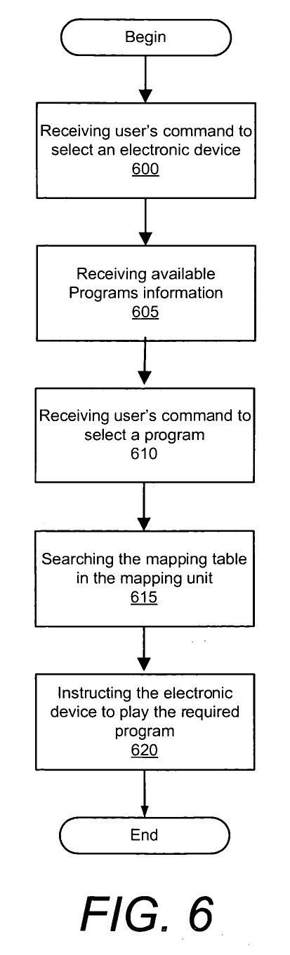

Reference is now made to FIG. 6 which depicts a process of tuning of an electronic device. As depicted in block 600, user interface 105 of a control unit 100 may receive instructions to select a particular electronic device 300. The user interface 105 may convert the instruction signals into digital and/or analog signals and convey the signal to a processor 110. The processor 210 processes the signals and identifies an electronic device and transmits the START signals to the intended electronic device 300 through a mapping unit interface 115. If the intended electronic device 300 is not ON then the START signal may switch ON the intended electronic device 300 to establish an association of the electronic device 300 with the control unit 100.

In block 605, and upon receiving the start signals a mapping unit 200 of the electronic device 300 starts sending the information packets to the control unit 100. The signals received from the mapping unit 200 may be conveyed to a processor 110 which may process the signals and store data regarding available programs in the memory 120.

In block 610, the user interface 105 may now wait to receive instructions from the user to play a particular program. Upon receiving the command from the user, the user interface 105 may convert the command signals into digital and/or analog signals and convey said signals to a processor 110. The processor 110 may process the instructions received from the user and retrieve the information regarding the requested program from available programs data 125 of the memory 120 and transmit the digital and/or analog command signals to the mapping unit 200 of the associated electronic device 300 through a mapping unit interface 115.

In block 615, a mapping unit 200 may receive the command signals from a control unit 100 for example a channel name through a control unit interface 205 and convey the signals to a processor 210. The processor processes the signals so as to identify the channel name and start searching a mapping table 225 in a memory 220, using the channel name.

In block 620, the processor identifies the channel name and retrieves the mapping frequency/playback selections from the mapping table 225. The mapping unit 200 then instruct intended electronic device 300 to be tuned to the corresponding frequency/playback selection so as to play the desired program. If the specified channel is not found then the mapping unit in the electronic device 300 triggers a frequency scan with this channel name and this operation may not affect running program if the device was already running.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising
receiving a request for a program from a control device,
determining a corresponding playback selection for the requested program based upon a mapping table that maps available programs to playback selections, and
requesting an electronic device to activate corresponding playback selection in order to play the requested program.

2. The method of claim 1 further comprising
receiving available programs data and corresponding playback selections data from the electronic device, and
generating the mapping table based upon the received available programs data and corresponding playback selections data.

3. The method of claim 1 further comprising
requesting available programs data and corresponding playback selections data from the electronic device,
receiving the available programs data and the corresponding playback selections data from the electronic device, and
generating the mapping table based upon the received available programs data and corresponding playback selections data.

4. The method of claim 1 wherein the available programs data identifies available television networks and the corresponding playback selection identify corresponding television channels for the available television networks.

5. The method of claim 1 wherein the available programs data identifies available radio networks and the corresponding playback selection identify corresponding radio frequencies for the available radio networks.

6. The method of claim 1 wherein the available programs data identifies available songs and the corresponding playback selection identify corresponding tracks for the available songs.

7. The method of claim 1 further comprising
sending available programs data to the control device for presentation to a user.

8. A system comprising
an electronic device to playback available programs,
a mapping unit to map the available programs to corresponding playback selections of the electronic device, and
a control unit to receive a user requests for an available program and to request the mapping unit to playback the available program.

9. The system of claim 8 wherein the mapping unit is integrated with the control unit.

10. The system of claim 8 wherein the mapping unit and control unit are integrated with the electronic device.

11. The system of claim 8 wherein the mapping unit is integrated with the electronic device.

12. The system of claim 8 wherein the control unit receives the user request as a spoken request.

13. The system of claim 8 wherein the control unit receives available programs data from the mapping unit to present available programs to a user.

14. The system of claim 8 further comprising another electronic device to playback other available programs, wherein
the mapping unit maps the other available programs to playback selections of another electronic device.

15. The system of claim 8 wherein the available programs of the electronic device correspond to television networks and the playback selections identify corresponding television channels for the television networks.

16. The system of claim 8 wherein the available programs of the electronic device correspond to radio networks and the playback selections identify corresponding radio frequencies for the radio networks.

17. The system of claim 8 wherein the available programs of the electronic device correspond to songs and the playback selections identify corresponding tracks for the songs.

18. A control unit comprising
a memory to store available programs data identifying available programs of an electronic device,
a user interface to receive a user request for an available program of the electronic device, and
a mapping unit interface to request playback of the available program identified by the user request.

19. The control unit of claim 18, wherein the user interface receives the user request as a spoken request.

20. The control unit of claim 18, wherein the user interface presents the available programs of the electronic device.

21. The control unit of claim 18, wherein the mapping unit interface receives the available programs data from a mapping unit that interacts with the electronic device.

22. The control unit of claim 18, wherein the memory further stores other available programs data identifying other available programs of another electronic device.

23. A machine readable medium comprising a plurality of instructions that in response to being executed result in a mapping unit
receiving a request for a program,
determining a corresponding playback selection for the requested program, and
requesting an electronic device to activate the corresponding playback selection in order to play the requested program.

24. The machine readable medium of claim 23 wherein the plurality of instruction further result in the mapping unit
receiving available programs data and corresponding playback selections data from the electronic device, and
determining the corresponding playback selection for the requested program based upon the received available programs data and corresponding playback selections data.

25. The machine readable medium of claim 23 wherein the plurality of instructions further result in the mapping unit sending the available programs data to the control device for presentation to a user.
